(19) United States
(12) Patent Application Publication
(10) Pub. No.: US 2026/0210991 A1
(43) Pub. Date: Jul. 23, 2026

(54) LIQUID TRANSFER

(71) Applicant: Thermo Fisher Scientific (Bremen) GmbH, Bremen (DE)

(72) Inventors: Ayrat Murtazin, Bremen (DE); Murtazin A. Makarov, Bremen (DE)

(73) Assignee: Thermo Fisher Scientific (Bremen) GmbH, Bremen (DE)

(21) Appl. No.: 19/134,881

(22) PCT Filed: Dec. 5, 2023
(86) PCT No.: PCT/EP2023/084222

§ 371 Date: Jun. 2, 2025

(30) Foreign Application Priority Data
Dec. 5, 2022 (GB) 2218239.8

(51) Int. Cl. G01N 35/10

(52) U.S. Cl. CPC G01N 35/1016

(57) ABSTRACT

A liquid transfer device comprises a reservoir for containing liquid, a dispenser for dispensing the liquid, a pump for pressurizing the liquid, a housing for accommodating the pump and part of the reservoir, and a controller for driving the dispenser and the pump. The liquid transfer device is arranged for operating in three selectable modes: a first mode in which the liquid transfer device produces individual droplets of liquid using the dispenser only, a second mode in which the liquid transfer device produces a stream of liquid using the pump only, or a third mode in which the liquid transfer device produces a jet of droplets of liquid using both the dispenser and the pump.

### FIELD OF THE DISCLOSURE

The present disclosure relates to liquid transfer, such as liquid transfer in analytical instruments. More in particular, the present disclosure relates to a liquid transfer device for transferring liquid, for example from a container to an analytical instrument.

### BACKGROUND OF THE DISCLOSURE

In many fields of science and technology it is desired to transfer known amounts of liquids from a first location to a second location, for example from a sample vessel to an analytical instrument. Such an instruments may be a spectrometer, for example. Various types of spectrometers exist, such as mass spectrometers and optical spectrometers. The required liquid volumes, flow rates and the kinds of liquid delivery (droplets, drops, flow, jet) differ significantly between the various types of analytical instruments.

In some applications it is desired that liquid is transferred in dispersed form. Depending on the required flow rate, the liquid transfer may be carried out in the form of a specified number of single monodisperse droplets or of a continuous stream of droplets. Similar requirements can also arise in the manufacturing of particulate substances by dispersion and desolvation of solutions, for example in the chemical and biochemical industry.

U.S. Pat. No. 9,892,900 (Thermo Fisher Scientific) discloses a liquid injection device capable of loading sample-containing liquid and ejecting at least some of the sample-containing liquid either in the form of droplets or in the form of a jet which subsequently breaks up into droplets.

U.S. Pat. No. 3,902,083 discloses a pulsed droplet ejecting system including an electro-acoustic transducer coupled to liquid.

Prior art devices have the disadvantage that many different devices are typically needed to provide many different liquid transfer rates. Sometimes the required liquid transfer rates are extremely low, in the order of microliters per minute (μL/min), which typically requires special equipment.

Liquid transfer may not only involve transferring liquid from a container to an analytical device, but also transferring liquid between containers or surfaces of various types. Thus, liquid transfer may involve transferring liquid from a first container to a second container, which containers are spaced apart and not connected by a fluid duct, by withdrawing fluid from the first container and depositing fluid in the second container. For this type of liquid transfer, a manually operated pipette is traditionally used. However, manually operating pipettes is time-consuming and may not result in the required accuracy, especially for small volumes and low flow rates.

### SUMMARY OF THE DISCLOSURE

In order to overcome these and other problems of the prior art, the present disclosure provides a liquid transfer device for transferring liquid, the liquid transfer device comprising:
a reservoir for containing liquid,
a dispenser for dispensing the liquid,
a pump for pressurizing the liquid,
a housing for accommodating the pump, and
a controller for driving the dispenser and the pump,
   wherein the liquid transfer device is arranged for operating in:
a first mode in which the liquid transfer device produces individual droplets of liquid using the dispenser only, or
a second mode in which the liquid transfer device produces a stream of liquid using the pump only, or
a third mode in which the liquid transfer device produces a jet of droplets of liquid using both the dispenser and the pump.

By combining a dispenser and a pump in a single liquid transfer device and by allowing the dispenser and the pump to be used in combination or individually, a range of liquid transfer modes and/or liquid transfer volumes can be provided by a single device.

Accordingly, the liquid transfer device may engage only the dispenser to produce individual droplets. Similarly, the liquid transfer device may engage only the pump to produce a stream of liquid. By engaging both the dispenser and the pump, the liquid transfer device may produce a jet of droplets. Thus, the controller can be configured for engaging the dispenser and/or the pump, in response to a suitable control signal, for example. The controller may further be configured to cause the dispenser and/or the pump to produce different liquid delivery speeds. The liquid transfer device can be configured such that the dispenser and the pump operate on the same reservoir and therefore on the same body of liquid.

Although the reservoir or receptacle may have various shapes, it may be elongate. A substantially elongate shape allows the reservoir to be accessible by various parts of the liquid transfer device, such as the dispenser and the pump. In some embodiments, only part of the reservoir may be elongate. In some embodiments, the reservoir may be constituted by a conduit or a capillary. Thus, a conduit for transferring liquid within the device may also be used for storing liquid.

The reservoir may extend through the dispenser to the pump and optionally into the pump. Thus, the reservoir may extend from its open end at one end of the dispenser to the opposite end of the dispenser at which the pump may be located. The reservoir may then further extend into the pump and even, in some embodiments, through the pump. Although the reservoir may be straight, it may contain at least one curve in its longitudinal direction. The diameter of the reservoir may be substantially constant or may vary. For example, the diameter of the reservoir may be greater at or in the pump than at or in the dispenser.

The reservoir may have a nozzle at an end of the dispenser. The nozzle may be formed to produce droplets, a stream or a jet of the desired dimensions. At least part of the reservoir may be accommodated in the housing.

The dispenser may be a piezo-electric dispenser, preferably a front-loaded piezoelectric dispenser. However, other types of dispensers may also be used, for example electromechanical dispensers.

The pump may be configured for alternatively providing an overpressure and an underpressure. This allows the device to aspirate liquid and to dispense liquid. The pump may be a displacement pump, preferably an air displacement pump. The pump may be arranged as a metering pump for metered liquid transfer.

The pump may be a piezo-electric pump. However, other types of pumps may also be used, such as a pump provided with an electrical motor of the conventional type configured to provide a rotation and/or a translation.

The liquid transfer device may further comprise a flow meter arranged between the dispenser and the pump. In some embodiments, the flow meter may be arranged in the dispenser.

The liquid transfer device may further comprise an orifice for supplying liquid to the reservoir, the orifice preferably being provided with a valve. Such an orifice, in addition to the open end or nozzle, allows liquid to be supplied to the reservoir without using the nozzle.

The reservoir may have an outer diameter of less than 2 mm, preferably approximately 1 mm. However, larger outer diameters than 2 mm are also possible, for example larger than 5 mm or larger than 10 mm.

The reservoir may have a nozzle with an internal diameter in a range of 10 to 100 μm, preferably in a range of 30 to 100 μm. However, nozzles having a greater internal diameter may, depending on the particular application, also be used. Thus, nozzles having an internal diameter greater than 100 μm may be used, for example greater than 0.5 mm or greater than 1.0 mm.

The liquid transfer device may be a hand-held device. Thus, the dimensions and the weight of the device may be chosen in such a way that the device can be operated when held in a hand. The liquid transfer device may have a weight of less than approximately 100 g, preferably less than approximately 50 g, for example less than approximately 30 g. This allows the liquid transfer device to be easily used as a hand-held device. A liquid transfer device having a low weight (mass), as mentioned above, can also be advantageous for use in an autosampler, for example, or for use with a movable arm, such as a robotic arm.

The liquid transfer device may have a length of less than approximately 25 cm, preferably less than approximately 20 cm, more preferably less than approximately 15 cm. The liquid transfer device may have a cross-section (or thickness) of less than approximately 7.5 cm, preferably less than approximately 5 cm, more preferably less than 3 cm.

The liquid transfer device may further comprise a controller and/or a driver for controlling and/or driving at least one of dispenser and the pump. The controller may be configured for, in response to control input, activating at least one of the dispenser and the pump.

The liquid transfer device may further comprise a battery, such as a rechargeable battery, for powering the dispenser, the pump, the driver and/or the controller. However, the liquid transfer device may also be powered by an external power supply via a cable.

The present disclosure also provides a software program product allowing a processor to control the pump and/or the driver of a liquid transfer device according to any of the preceding claims.

The present disclosure additionally provides an analytical system comprising at least one liquid transfer device as described above. The analytical system may comprise a spectrometer and an optional autosampler. The spectrometer may be a mass spectrometer or an optical spectrometer. The present disclosure therefore further provides a spectrometer, such as a mass spectrometer or an optical spectrometer, comprising a liquid transfer device as described above.

The present disclosure still further provides the use of a liquid transfer device as described above.

### BRIEF DESCRIPTION OF THE DRAWINGS

FIGS. 1A-1C schematically show cross-sectional views of exemplary embodiments of a liquid transfer device according to the present disclosure.

FIG. 2 schematically shows a cross-sectional view of a further exemplary embodiment of a liquid transfer device according to the present disclosure.

FIGS. 3A & 3B schematically show the exterior of embodiments of a liquid transfer device according to the present disclosure.

FIGS. 4A and 4B schematically show a side view and a front view of a loading station comprising a liquid transfer device according to the present disclosure.

FIG. 5 schematically shows a perspective view of an autosampler comprising a liquid transfer device according to the present disclosure.

FIG. 6 schematically shows a method according to the present disclosure.

### DETAILED DESCRIPTION OF THE DRAWINGS

The present disclosure provides a liquid transfer device for transferring liquid, for example from a vial to an analytical instrument, such as a spectrometer, or between vials, or between analytical instruments. The liquid transfer device of the present disclosure may additionally, or alternatively, be used in an autosampler and/or in a loading station. The liquid transfer device of the present disclosure may be a hand-held device and/or may be built into an analytical system, for example an analytical system comprising a mass spectrometer or an optical spectrometer, and/or an analytical system comprising an autosampler and/or a loading station.

As will be clear from the description below, the synergy of a piezo-electric dispenser and a pump is utilized to provide liquid transfer devices that can be used over a wide range of fluid delivery rates.

The liquid transfer device is arranged for operating in a first mode in which the liquid transfer device produces individual droplets of liquid using the dispenser only, or a second mode in which the liquid transfer device produces a stream of liquid using the pump only, or a third mode in which the liquid transfer device produces a jet of droplets of liquid using both the dispenser and the pump.

Although the following description relates to a liquid transfer device having a single reservoir, a single dispenser and a single pump, the disclosure is not so limited. Accordingly, the liquid transfer device according to the present disclosure may comprise two, three or more reservoirs. A single dispenser and a single pump may transfer liquid of two or more reservoirs. Alternatively, or additionally, two or more dispensers and/or two or more pumps may transfer liquid of a single reservoir. Accordingly, in some embodiments having multiple reservoirs, each reservoir may be provided with a dedicated dispenser and a dedicated pump.

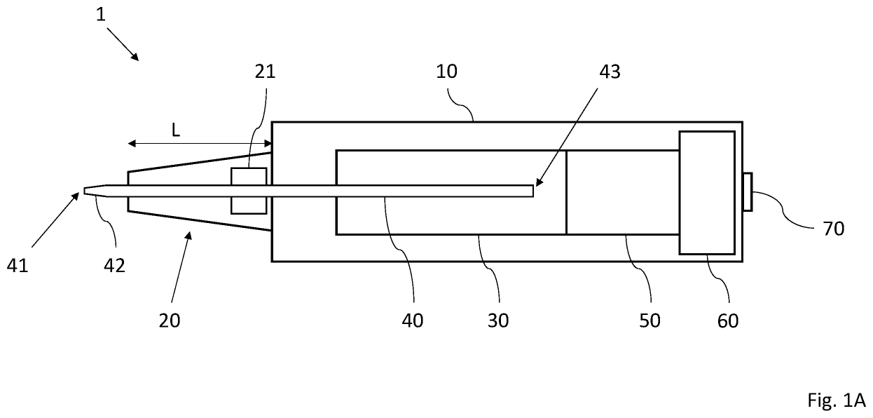

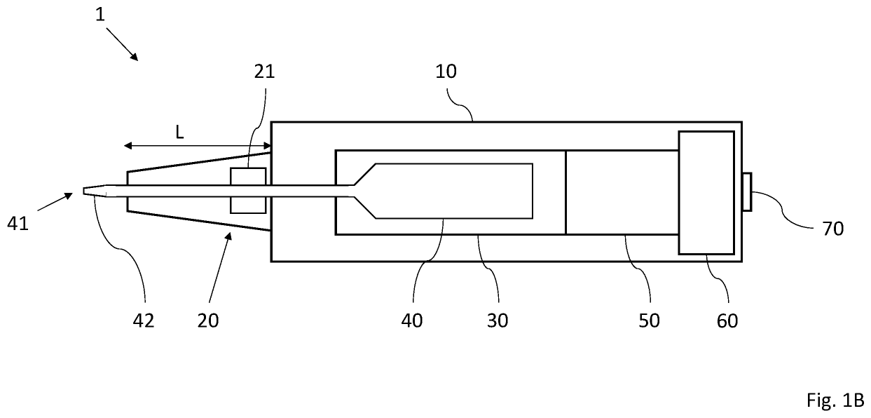

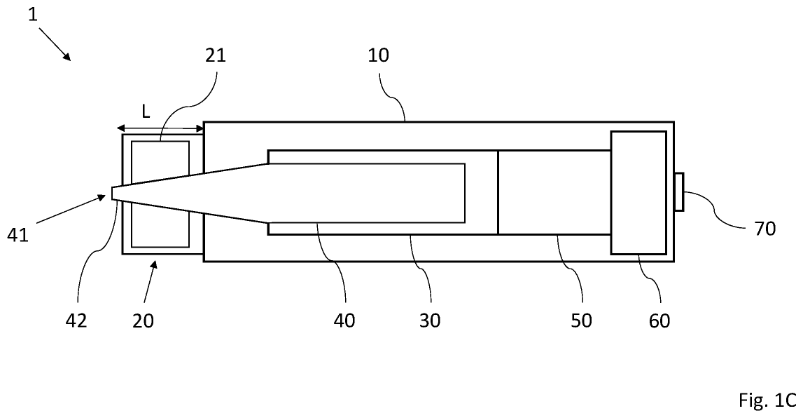

An exemplary embodiment of the liquid transfer device according to the present disclosure is schematically illustrated in FIG. 1A. The liquid transfer device 1 of FIG. 1A comprises a housing 10, a dispenser 20, a pump 30, a reservoir 40, a driver 50, a battery 60 and a controller 70. The reservoir or receptacle 40 is, in the embodiment shown, elongate and may be constituted by a capillary. The reservoir 40 of FIG. 1A is provided with a tapered section 42 near its open end 41. This tapered section 42 serves to provide a narrow liquid flow (droplets, stream, or jet) while allowing the reservoir to have a sufficient capacity due to being wider over most of its length. It is noted that the opposite end 43 of the reservoir 40 is closed in some embodiments but may be open in other embodiments. In the embodiment shown in FIG. 1A, part of the reservoir 40 is accommodated in the housing 10. In addition, in this exemplary embodiment the pump 30, the driver 50 and the battery 60 are accommodated in the housing 10.

The dispenser 20 of FIG. 1A is also tapered. In particular, the dispenser 20 of FIG. 1A has a frustoconical shape. In some embodiments, however, the dispenser 20 is not tapered, or only tapered over part of its length, another part being tubular, for example. The dispenser may extend from the housing 10 but may also be arranged in the housing.

The dispenser 20 is provided with one or more transducers 21, which may be piezo-electric elements. The transducer or transducers 21 may constitute a tubular transducer assembly which may be arranged at least partially but preferably wholly inside the dispenser 20.

In the embodiment shown, the transducer or transducers 21 are arranged within the housing 10, spaced apart from the open end 41 of the reservoir 40. In the embodiment of FIG. 1A, the dispenser part of the housing 10 extends beyond the main part of the housing 10 over a distance L. In the example of FIG. 1, the length L is approximately one-third of the total length of the dispenser 20. In other embodiments, the length L may be greater or smaller. Thus, a length L of close to zero, or substantially equal to zero, is also feasible. In the embodiment shown, the tapered section or tip 42 extends beyond the frustoconical dispenser section 20.

The pump 30 may surround part of the reservoir 40, as shown. The pump 30 may be provided with an electrical motor or may be a piezo-electrical pump. The pump 30 may be known per se.

The driver 50 is connected to the dispenser 20 and the pump 30 so as to switch the dispenser and/or the pump on and off.

The battery 60 can be configured for providing electrical power to the dispenser 20, the pump 30, the driver 50 and the controller 70. The battery 60 may be a rechargeable battery and/or may be replaceable.

The controller 70 may be capable of controlling the amplitude and/or frequency of the vibrations of the dispenser, and/or the pump speed. The controller may comprise a single-chip control unit and/or a microprocessor with an associated memory.

The controller 70 may contain one or more buttons which can be pressed by an operator. Alternatively, or additionally, the control panel 70 may constitute an interface with another device, such as an autosampler, from which it can receive control commands. The controller 70 can be connected with the driver 50.

The embodiment of FIG. 1B is similar to the one of FIG. 1A, with the exception of the diameter or cross-section of the reservoir 40. It can be seen that the reservoir 40 of FIG. 1B has a varying diameter (apart from the nozzle 42) which increases within the pump section 30, thus increasing the volume of the reservoir. The nozzle 42 extends from the dispenser 20.

The embodiment of FIG. 1C is similar to the ones of FIGS. 1A and 1B, with the exception of the diameter or cross-section of the reservoir 40. In the embodiment of FIG. 1C, the nozzle section 42 is longer and wider, and leads into a widened straight section of the reservoir 40. It will be clear that the reservoir of FIG. 1C has a larger volume than the reservoir of FIG. 1B, which in turn has a larger volume than the reservoir of FIG. 1A. Various other shapes and sizes of the reservoir 40 are also possible, including reservoirs that are not straight but curved in their longitudinal direction.

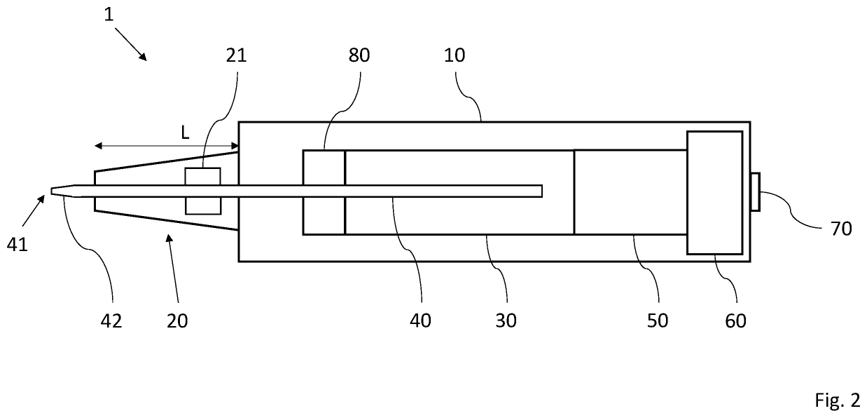

The liquid transfer device 1 of FIG. 2 also comprises a housing 10, a dispenser 20, a transducer 21, a pump 30, a reservoir 40, a driver 50, a battery 60 and a controller 70. In addition, the embodiment of FIG. 2 comprises a flow meter 80. Such a flow meter can be capable of measuring a liquid flow through the reservoir 40 at the location of the flow meter 80. Thus, the liquid flow into or from the reservoir 40 can be measured. It will be understood that the flow meter 80 can be connected to the controller 50 by wires or, in some embodiments, wirelessly. The flow meter 80 can also be electrically powered by the battery 60.

In the embodiment of FIG. 2, the reservoir 40 not only extends through the dispenser 20 and, at least partially, through the pump 30, but also through the flow meter 80 which is arranged between the dispenser 20 and the pump 30. As noted above, the reservoir 40 may be elongate. The reservoir may be constituted by a conduit for conveying and/or containing liquid. In other embodiments, the reservoir 40 may not be elongate and may be relatively wider, as for example illustrated in FIGS. 1B & 1C, to increase the liquid volume that can be handled during a single use of the liquid dispensing device.

The reservoir 40 can be used to temporarily store liquid. To this end, the pump 30 may be arranged for reducing the air pressure in the reservoir 40 so as to aspirate liquid into the reservoir. Conversely, the pump 30 may be arranged for increasing the air and/or liquid pressure in the reservoir 40 so as to dispel liquid from the reservoir. In some embodiments, the reservoir 40 may be provided with an air duct and an associated orifice (not shown) open to the outside of the housing 10 to allow air to be aspirated.

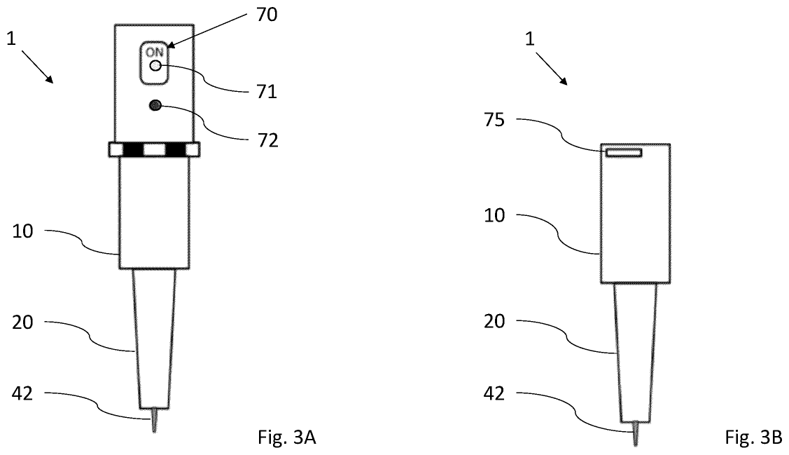

Examples of the exterior of a liquid dispensing device of the present disclosure are shown in FIGS. 3A and 3B. The liquid dispensing device 1 is shown to comprise a housing 10, a dispenser or dispenser section 20 extending from the housing 10, and a tapered section or tip 42 of the reservoir (40 in FIGS. 1 & 2) extending from the dispenser 20. The housing 10 is provided with a control panel of the controller 70. Indicator lights 71 and 72, which may be green and red respectively, for example, are provided on the housing 10. The housing may contain at least a pump, a driver and a battery.

The liquid dispensing device 1 of FIG. 3B also has a housing 10, a dispenser 20 and a tapered reservoir section 42 extending from the dispenser 20. The housing is provided with a controller interface 75. The embodiment of FIG. 3A may be a hand-held device. That is, its dimensions, weight and/or shape is suitable for being held in a hand. The embodiment of FIG. 3B is particularly suitable for use with a robotic arm, for example. That is, its weight and dimensions make it suitable for being accelerated and decelerated quickly.

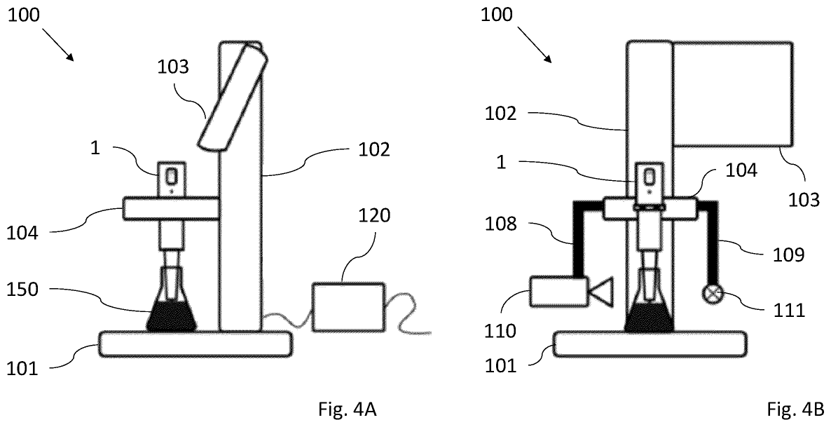

A loading station 100 is shown in front view in FIG. 4A and in side view in FIG. 4B. The loading station 100 is shown to comprise a base 101, a body 102 mounted on the base 101, a control panel 103 mounted on the body 102, and a support 104 extending from the body 102. The support 104 is arranged for holding a liquid transfer device 1. The loading station 100 may be connected to a power supply 120. In addition, the loading station 100 may be connected by wires or wirelessly to a data network for exchanging data with a computer. The control panel 103 may include a screen, such as a touch screen, and/or an actual or virtual keyboard. The base 101 is arranged for supporting at least one vial 150, which may contain a fluid sample. Sideview is best.

The support 104 may be movably mounted on the body 102 such that its distance from the base 101 can be varied. In particular, the support 104 may be arranged to move down to insert the liquid transfer device 1 into the vial 150 and to move up to retract the liquid transfer device 1 from the vial 150. To this end, one or more electrical motors and or a spring can be arranged inside the body 102 and/or the support 104.

As shown in FIG. 4B, the support 104 may be provided with a first arm 108 for mounting a camera 110 and an optional second arm 109 for mounting a light source 111. The camera 110 and the light source 111 are arranged at approximately the same height as the dispenser (20 in FIG. 3A) of the liquid dispensing device 1, in particular approximately at the same height as the tapering section (42 in FIG. 3) of the reservoir of the liquid dispensing device, such that the camera image contains the fluid surface and/or the ejected droplets. The loading station may further comprise at least one position sensor to determine the position of the liquid dispensing device relative to the base. The loading station may still further comprise a sample recognition unit, which may include a bar code reader and/or an RFID (radio frequency identification) tag reader.

The camera 110 and the light source 111, which may be a stroboscopic light, can be provided to:
1) control the state of dispenser surface (to facilitate loading and maintenance/troubleshooting), and/or
2) characterize droplets (their size, velocity and direction).

So point 2) is an alternative way to specify the liquid flow rate (which is the product of droplet volume and repetition frequency); velocity and direction are free additions to monitor constant droplet generation conditions.

Thus, the fluid dispensing device 1 of the present disclosure can be used to withdraw a fluid sample from a vial 150, as shown in FIGS. 4A and 4B. Similarly, the fluid dispensing device 1 of the present disclosure can be used to inject a fluid sample into a vial.

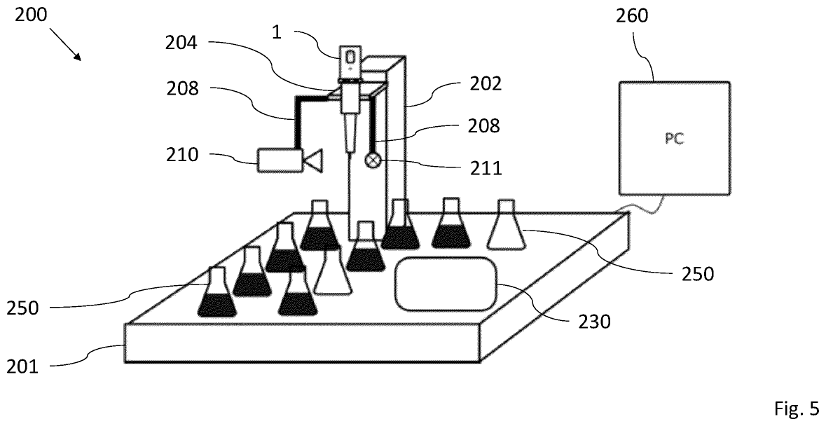

Although the use of the fluid dispensing device 1 of the present disclosure in a loading station 100 is shown in FIGS. 4A & 4B, the use of the fluid dispensing device 1 of the present disclosure is not limited to loading stations but extends to hand-held use and the use in autosamplers, as is illustrated in FIG. 5.

An exemplary autosampler comprising a liquid transfer device according to the disclosure is shown in FIG. 5. The autosampler 200 is shown to comprise a base 201, a body 202, and a support 204 extending from the body 202. A liquid transfer device 1 according to the disclosure is mounted on the support 204. A first arm 208 and a second arm 209 extend from the support 204. A camera 210 is mounted on the first arm 208 while a light 211 is mounted on the second arm 209. The autosampler 200 is connected to a computer (PC) 260.

Several vials 250 can be arranged on the base 201. In the example shown, a target object 230 is also arranged on the base 201. The target object 230 may be a vessel into which a liquid sample is to be deposited or a plate onto which a liquid sample is to be deposited.

The support 204 may be arranged for moving away from (upwards) or towards (downwards) the base 201.

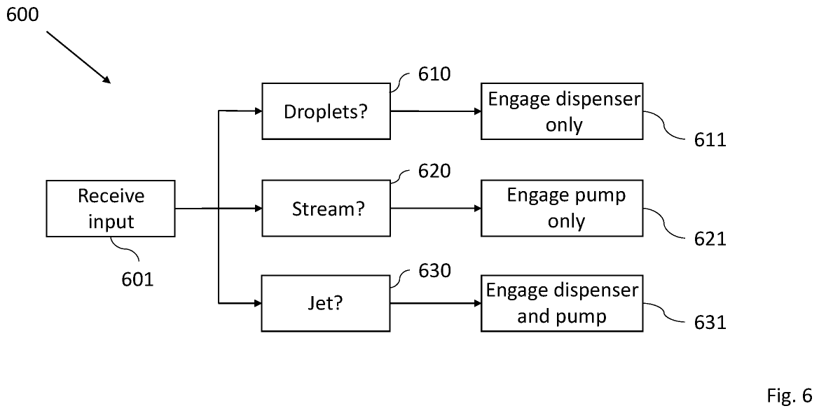

Operating a liquid transfer device according to the disclosure is schematically illustrated in FIG. 6. The controller 50 of the liquid transfer device may control this operating.

In accordance with the present disclosure, the liquid transfer device is arranged for operating in:
a first or droplets mode in which the liquid transfer device produces individual droplets of liquid using the dispenser only, or
a second or stream mode in which the liquid transfer device produces a stream of liquid using the pump only, or
a third or combined mode in which the liquid transfer device produces a jet of droplets of liquid using both the dispenser and the pump.

Accordingly, the operating method 600 starts at 601 and receives input. The input, which may comprise control signals, may be received from a control panel (70 in FIG. 1) on the device, or from a remote device, such as an analytic apparatus with which the liquid control device may be connected by wires or wirelessly. The input may comprise direction, volume, flow rate and/or form (such as droplets, stream, jet).

If the input refers to droplets (610), only the dispenser is activated (611). If the input corresponds with a stream of liquid (620), then only the pump is activated (621). If the input corresponds with a jet of droplets (630), both the dispenser and the pump are engaged (631).

Thus, depending on the input, the controller activates either the dispenser only (611), or the pump only (621), or the dispenser and the pump combined (631). This allows liquids to be transferred in various ways.

It is noted that the input may additionally comprise information regarding the liquid flow (mm³/s or μL/min) and the direction of the flow (taking in liquid or dispensing liquid). This allows liquids to be dispensed at various speeds. The flow rate in first mode is the product of the droplet volume and the droplet repetition frequency. The droplet volume may be suitably measured.

Switching from the first mode to the second or third mode may take place at a predefined liquid flow rate in a range of:

$$< 50 μL / min , \qquad a )$$

$$< 10 μL / min , \qquad b )$$

$$< 5 μL / min , \qquad c )$$

$$< 1 μL / min , \qquad d )$$

$$< 500 nL / min , \qquad e )$$

$$< 100 nL / min . \qquad f )$$

The predefined flow rate may be determined during a calibration process, preferably automatically, and optionally with an optical measurement of droplets.

The liquid transfer device can be used in at least two positions:
a dispensing position, for example in or above a target object, such as a MALDI (Matrix-Assisted Laser Desorption/Ionization) plate, an ETA-AA (Electro-Thermal Atomization-Atomic Absorption) furnace, or a gas adaptor connected to an ICP (Inductively Coupled Plasma) torch; and
a loading position, for example in or above a sample vessel, which may comprise:
   an initial, zero or top position, for example above a sample vessel, and
   a loading/rinsing position, for example in (or just above) a sample vessel.

When using a loading station, both positions may be in the station. Alternatively, only the loading position is in the loading station while the dispensing position is elsewhere, for example directly at an analytical instrument, such as a spectrometer.

The following operational steps can be conducted as an example of a loading station embodiment when the loading station uses the loading position only:
1. The liquid transfer device is moved to loading position of the station, for example manually;
2. The liquid transfer device is in a holder of the loading station, in an initial or zero position. Its battery or supercapacitor may be charged. This state may be sensed automatically by a sensor, for example an optocoupler, and be communicated to a controller.
3. The holder moves downward (Z-axis movement), driven manually or by a motorized stage, until the tip of the liquid transfer device comes in contact with the liquid in the vessel. A capacitance or pressure sensor can be used for detecting the liquid level automatically;
4. The holder moves further down, for example approximately 2 mm, and then stops, leaving the tip of the liquid transfer device immersed in the liquid;
5. An amount of liquid is aspirated into the liquid transfer device. This amount is normally slightly larger than the amount required to be dispensed. The amount can be set manually or automatically using information which may be calculated from a path travelled by a syringe plunger or measured by a liquid flow meter;
6. The holder moves upward up to the initial (zero) position;
7. Optionally, test droplets may be dispensed in this position. The droplet size can be measured and any required adjustments may be made by the controller or operator to achieve the desired droplet characteristics.
8. The loaded state may be indicated by a visual and/or audible and/or digital “Ready” signal;
9. The liquid transfer device is moved to the dispensing position, for example a MALDI target, ETA-AA furnace or ICP-MS gas transport means;
10. The required amount of liquid is dispensed on/in to target object. This amount may be calculated from a measured droplet size and repletion frequency or may be measured by the liquid flow meter.

The tip of the liquid transfer device may be exchanged or rinsed between dispensing and loading steps, once or several times. Any aspirated rinsing liquid may be dispensed into a waste container or waste line. The dispensing position may be in the loading station. The liquid transfer device may be moved into a dispensing position by rotation and/or translation. A controller may store all required information in a non-volatile memory. The controller may be configured for causing the loading station to carry out some or all of the above or other steps automatically. Alternatively, or additionally, the controller may be configured to provide auditive and/or visual hints or instructions to an operator.

The liquid transfer device may be used for sample preparation, such as automatic protein digestion, labeling, dispensing, etc. for a broad range of applications: metabolomics, proteomics, protein characterization, translational research, etc., especially for small sample volumes like in single-cell analysis. However, the use of the liquid transfer device is not so limited.

The present disclosure also provides a software program product configured for controlling the driver of the liquid transfer device. Thus, the software program product can be configured to cause the driver to carry out the method according to the present disclosure.

It will be understood by those skilled in the art that the present disclosure is not limited to the embodiments described above and that many additions and modifications may be made without departing from the scope of the disclosure as defined by the appending claims.

1. A liquid transfer device for transferring liquid, the liquid transfer device comprising:
a reservoir for containing a liquid,
a dispenser for dispensing the liquid,
a pump for pressurizing the liquid,
a housing for accommodating the pump, and
a controller for driving the dispenser and the pump, wherein the liquid transfer device is arranged for selectively operating in:
a first mode in which the liquid transfer device produces individual droplets of the liquid using the dispenser only,
a second mode in which the liquid transfer device produces a stream of the liquid using the pump only, or
a third mode in which the liquid transfer device produces a jet of droplets of the liquid using both the dispenser and the pump.

2. The liquid transfer device according to claim 1, wherein the reservoir is elongate.

3. The liquid transfer device according to claim 1, wherein the reservoir extends through the dispenser to the pump.

4. The liquid transfer device according to claim 1, wherein the reservoir has a nozzle at an end of the dispenser.

5. The liquid transfer device according to claim 1, wherein the dispenser is a piezo-electric dispenser, preferably a front-loaded piezoelectric dispenser.

6. The liquid transfer device according to claim 1, wherein the pump is configured for alternatively providing an overpressure and an underpressure.

7. The liquid transfer device according to claim 1, wherein the pump is a displacement pump.

8. The liquid transfer device according to claim 1, wherein the pump is arranged for metered liquid transfer.

9. The liquid transfer device according to claim 1, wherein the pump is a piezo-electric pump.

10. The liquid transfer device according to claim 1, further comprising a flow meter arranged between the dispenser and the pump.

11. The liquid transfer device according to claim 1, further comprising an orifice for supplying liquid to the reservoir.

12. The liquid transfer device according to claim 1, wherein the reservoir has an outer diameter of less than 2 mm.

13. The liquid transfer device according to claim 1, wherein the reservoir has a nozzle with an internal diameter in a range of 10 to 100 mm.

14. The liquid transfer device according to claim 1, further being arranged for operating in an aspiration mode in which the liquid transfer device aspires liquid.

15. The liquid transfer device according to claim 1, which is a hand-held device.

16. The liquid transfer device according to claim 1, wherein the liquid transfer device has a weight of less than 100 g.

17. The liquid transfer device according to claim 1, wherein the liquid transfer device has a length of less than 25 cm.

18. (canceled)

19. The liquid transfer device according to claim 1, further comprising a battery for powering one or more of the dispenser, the pump, a driver coupled to the dispenser and the pump, and the controller.

20. A software program product comprising processor-executable instructions that cause a liquid transfer device to selectively operate in a first mode, a second mode, or a third mode, wherein
in the first mode, the liquid transfer device produces individual droplets of liquid using a dispenser only,
in the second mode, the liquid transfer device produces a stream of a liquid using a pump only, and
in the third mode, the liquid transfer device produces a jet of droplets of the liquid using both the dispenser and the pump.

21. An analytical system, comprising at least one liquid transfer device according to claim 1.

22. The analytical system according to claim 21, comprising a mass spectrometer and/or an optical spectrometer.

23. The analytical system according to claim 21, further comprising an autosampler.

24. The analytical system according to claim 21, further comprising a loading station.

25. A method of transferring a liquid, comprising:
selecting one of individual droplets, a stream of the liquid, or a jet of droplets for liquid transfer; and
controlling a liquid transfer device having a pump and a dispenser to dispense the liquid based on the selection, so that the individual droplets are dispensed with the dispenser only, the stream of the liquid is dispensed with the pump only, and the jet of droplets is dispensed with the dispenser and the pump based on the selection.
